(19) United States
(12) Patent Application Publication
(10) Pub. No.: US 2008/0250709 A1
(43) Pub. Date: Oct. 16, 2008

(54) Waste Water Distribution System

(76) Inventor: Peter Shepherd-Wilson, Victoria (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/628,171

(22) PCT Filed: Jun. 1, 2005
(86) PCT No.: PCT/AU2005/000774

§ 371 Date: Dec. 6, 2007

(30) Foreign Application Priority Data
Jun. 2, 2004 (AU) 2004902930

(51) Int. Cl. A01G 25/00

(52) U.S. Cl. 47/48.5

(57) ABSTRACT

A system that is gravity forced for distributing wastewater to plant material (107, 108), composing a water receiving means (105), a lint trapping means (508) within the receiving means (105), inlet and outlet devices of the receiving means (105) and an irrigation means (109, 110) for transporting water from the receiving means to specified parts of a garden as determined by an operator.

### FIELD OF INVENTION

The present invention relates to the field of waste water distribution. In one form, the invention relates to a household greywater (washing water, bath and shower water) distribution system that is gravity fed. It will be convenient to hereinafter describe the invention in relation to a household greywater distribution system, however it should be appreciated that the present invention is not limited to that use only.

### BACKGROUND ART

Due to population growth, governments and water providers struggle with the challenge of ensuring that each population has a sustainable supply of drinking water. As a result, reclaimed household wastewater (greywater) reuse is being viewed as a viable and sustainable way to reduce the consumption of potable water.

The single largest consumer of potable water within towns and cities is the domestic garden. Water suppliers in developed nations often report that approximately 35% of domestic water consumption can be attributed to our gardens. Reclaiming household greywater is one method that may be implemented to reduce domestic water consumption.

Reclaiming household greywater can however be fraught with horticultural, environmental and health risks. In addition, there are physical and engineering challenges involved in distributing water throughout a garden in a safe and efficient, maintainable manner. The inventor has identified that most currently available systems fall into disuse within a three years of being installed due to: mechanical failure; blockages; maintenance costs; odours; or being too difficult or time-intensive to maintain. Regardless of the level of filtration, greywater systems are also prone to the problem of blockages due to lint and hair build up. Due to fast multiplying bacteria in greywater when it is stored, odours rapidly build up and the risk of health issues arising are multiplied.

In urban areas suitable greywater source selection is an important issue, with kitchen and toilet water (or black-water) being the most risk prone to the above problems. The potential health and environmental risks associated with greywater require that greywater must be contained within the boundaries of the property that it originates from.

In response to these above problems identified by the inventor, single household domestic greywater reuse systems have previously been developed, however the maintenance requirements and costs of these systems means are high and each are often abandoned or not appropriately maintained by the households in which they are installed.

Alternatively, previous systems do not provide any efficient way of using the water to irrigate domestic gardens. Increasingly, householders who are aware of the situation are looking for simple alternatives to using tens or hundreds of thousands of litres of potable water to maintain their gardens.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide a system for distributing greywater.

A further object of the present invention is to alleviate at least one disadvantage associated with the prior art.

### SUMMARY OF INVENTION

The present invention provides for a system for distributing wastewater to plant material, comprising: water receiving means; lint trapping means within said receiving means; inlet and outlet devices of said receiving means; and irrigation means for transporting water from said receiving means; wherein wastewater is received and filtered by said receiving means and transported via irrigation means to plant material as determined by an operator.

The present invention further provides for a system wherein wastewater is transported from said receiving means to plant material by the force of gravity.

The present invention further provides for a system wherein said receiving means is elevated from the ground by a stand.

Other aspects and preferred aspects are disclosed in the specification and/or defined in the appended claims, forming a part of the description of the invention.

In essence, the present Invention provides for a household greywater distribution system that has a unique combination of components and is gravity fed and can be adjusted to allocate selected amounts of waste water to specified parts of a garden, as desired by the operator. The invention is comprised of a number of components that may be assembled to suit the requirements of the individual user.

The present Invention has been found to result in a number of advantages, such as being simple to operate and maintain by the average householder. The system also has minimal maintenance requirements to ensure that the system is not abandoned. Every component of the system is serviceable by the user which ensures that any problem can easily be rectified. The system is further durable in design and construction to ensure that potential water savings as a result of the system are realised.

The system advantageously utilises gravity to distribute the greywater with no pump required to distribute the water throughout a garden. It also allows the water to be distributed at rates at which plants are able to fully utilise the water they are being fed. The watering method creates a unique spread pattern that helps prevent root balling and other problems traditionally associated with sub-surface trickle Irrigation. The system further has an easy to change configuration, enabling an operator to water additional plants or garden beds using the system after it has been installed. The system is further portable and water saving can be in excess of 100 000 litres of potable water per year.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates an aerial view of system plumbing set out from a home on a block of land, in accordance with a preferred embodiment of the invention,

FIG. 2 illustrates a surge capsule in relation to a capsule stand, in accordance with a preferred embodiment of the invention,

FIG. 3 illustrates a front view of a three-way water diverter used in the system of the invention, in accordance with a preferred embodiment of the invention, and

FIG. 4 illustrates a front view of a wand for dispersing water, in accordance with a preferred embodiment of the invention.

### DETAILED DESCRIPTION

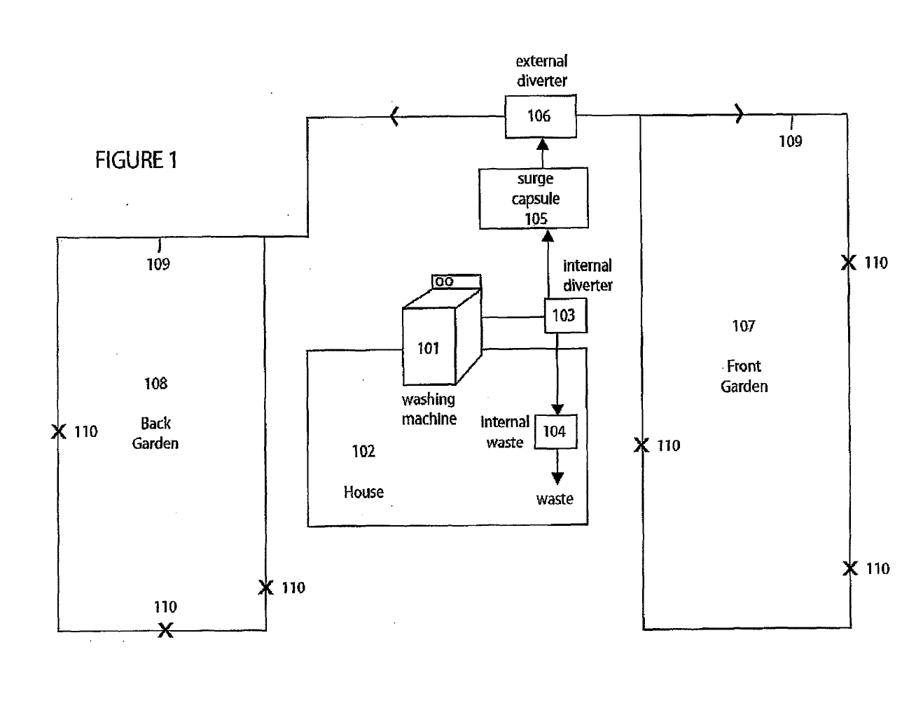

FIG. 1 illustrates a schematic view of one embodiment of the present invention. Greywater, for example from a washing machine 101 in a household 102 is regulated by from an internal diverter or suitable valve mechanism 103 to either an internal waste 104, such as a laundry trough, or to a surge capsule 105, such as a water tank or vessel. From there, the greywater can be regulated by a suitable mechanism 106, such as an external diverter, to feed one or more irrigation circuits, such as to either or both a front garden circuit 107 and/or a back garden circuit 108. Other gardens or irrigation systems may also be feed by the present invention by suitably connecting those systems to the greywater feed of the present invention.

In an embodiment of the invention, the garden circuits 107 and 108 include a 19 mm irrigation line 109 which preferably distributes water to the parts of the gardens that require irrigation, surrounding the house 102. Joining units (not shown) are adapted to connect lengths of the 19 mm irrigation line 109 as is necessary. Joiners may have a 7 mm long barbed into trunk line with a slightly rounded opening, which the water flows into. A hexagon shaped piece around the joiner allows a tool to be utilised to screw in the joiner. An 11 mm long circular joining length with a diameter of 8 joins the branch line to the joiner (not shown)

An irrigation outlet 110, such as an 8 mm PVC irrigation tube (not shown) is used to enable the greywater within the line 109 to soak into the surrounding earth/garden. Any suitable irrigation device may be used to achieve the soaking of the garden. The invention, however, is preferably gravity feed, thus enabling the greywater to ‘sit’ in the line 109 until it passes through outlets 110 into the surrounding garden 107, 108.

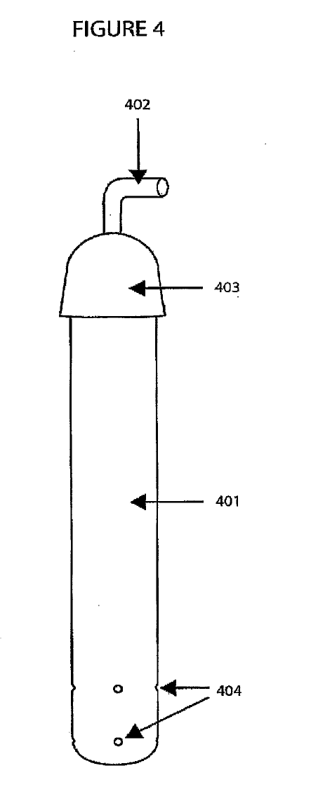

One form of outlet is illustrated in FIG. 4. The outlet(s) are referred to as a wand 401 and are placed to ensure that water is delivered to the root networks of plant material being watered. An 8 mm joiner 402 is built into a cap 403 of watering wand 401. The cap 403 is preferably releasably clipped onto the wand and allows for easy Inspection and clearing of each watering wand if necessary. The wand is placed substantially below the garden surface. The plastic tube of the wand 401 then transports water to between 120-160 mm below surface, depending on the length of the wand. A plurality of small holes 404 in the wall of the tube begin at 100 mm below the ground surface. The number and size of these holes 404 controls the flow of water from the wand 401. The tubes may differ in diameters for different soil conditions and flow rates: preferably 10 mm for sandy soil; 15 mm for loamy clay; and 20 mm for clay, but may be of any size or length as is required. The length of the tube will vary between 120 and 160 mm dependent on the type of plant being watered and soil conditions.

Flushing points (not shown) are fitted at various points around the system to allow for semi regular flushes to remove any build up or sediment from trunk lines of the system.

The system preferable includes an external three-way switch 106 to allow the water to be directed to alternative garden sectors to ensure that the system preferably completely drains and avoids the potential problem of waterlogging soils through over-watering.

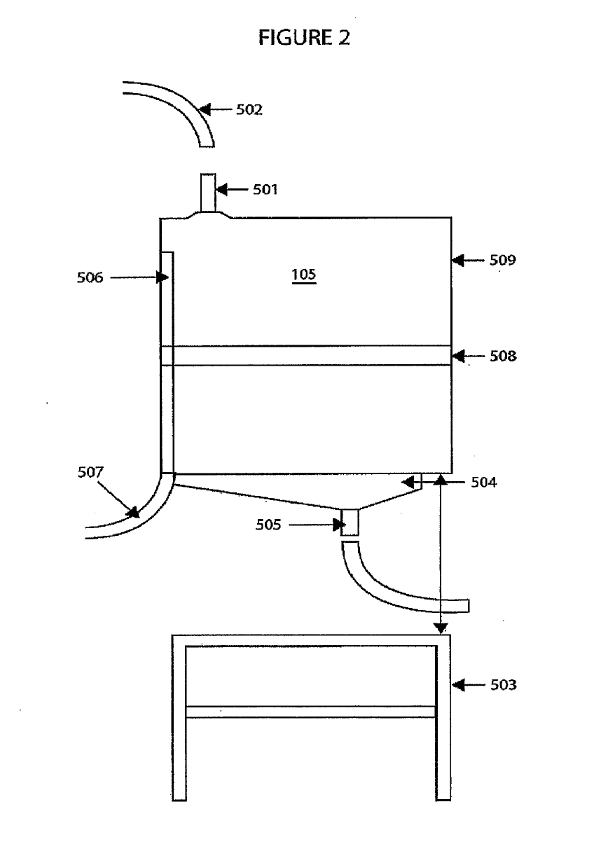

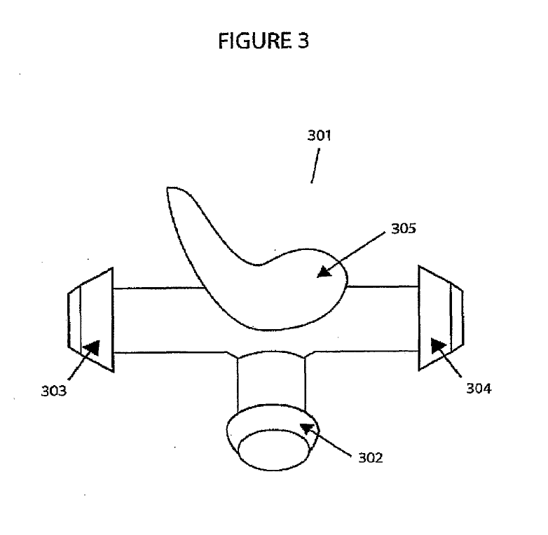

FIG. 3 illustrates a diverter switch 106, and may also be used as internal diverter/switch 103. In use, the three-way diverter 301 is provided on communication with a source of greywater. The external diverter 106 may be mounted onto a wall of a household laundry. The internal diverter may be mounter proximate a washing machine 101 in a laundry of the house 102. The wastewater hose from the washing machine is connected to the internal diverter 103. The water source Is connected to inlet 302. One of the outlets 303 is connected to an existing wastewater disposal system (i.e. laundry trough or waste pipe) 104. Another of the outlets 304 is connected to surge capsule 105 (FIG. 2) via capsule inlet 501, using connecting pipe 502. The directional lever 305 allows the user to direct wastewater to waste disposal 104 and/or the distribution system and the garden 107, 108. A pipe is fitted preferably on a gentle downward slope to feed the waste water from the outlet 304 to the surge capsule 105. The surge capsule 105 is preferably mounted on a stand 503, harnessing gravity to enable the water to flow some 100 metres or more.

The surge capsule provides an important feature in the present invention. It enables waste water to be gathered and slowly dispensed into the water feed system of line 109. In this way, the waste water can have time to soak into the soil via outlets 110. The surge capsule 105 has a sump 504 with a (preferably) outlet 505 which is built into a lower end of the capsule 105 to allow the surge capsule to completely drains each time it fills with waste water. An internal overflow 506 and associated pipe allows excess water to be feed to the waste outlet 104 or other external drainage system such as a gulley trap. A two-stage lint basket system 508 enables a majority of lint contained in the greywater to be prevented from entering the irrigation system and lines 109.

The external diverter 106 may also be connected to an approved septic or sewerage or other approved waste disposal system, in the event that the waste water Is not required to be feed to the garden, but simply to be disposed of. The 19 mm irrigation line 109 is then used to get the water to the parts of the garden that require irrigation and the 8 mm PVC irrigation tube (not shown) is utilised to take the water from the joiner to the watering wand(s) 401. The joiners are used to ensure that minimal maintenance is required to prevent blockages due to lint.

The surge capsule may be a roto-moulded or fibreglass surge capsule 509 in two alternative capacities of 100 and 200 litres and includes a 50 mm or larger inlet 501 at one end of the capsule to allow both the 25 mm inlet pipe 502 and airflow into the capsule. Sump 504 with a 25 mm male outlet 505 is built into the other end of the capsule 509 and a second 32 mm female overflow outlet 506 is fitted internal of the capsule to allow internal 32 mm overflow pipe 507 to be fitted inside capsule. The two or three-stage lint basket 508 inside the capsule 509 and ensures that the majority of the lint contained in the greywater is prevented from entering irrigation system. The baskets will alternatively be nylon or stainless steel in composition.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1-15. (canceled)

16. A system for irrigating plant material with waste water, including a tank adapted to receive and store waste water for a relatively short period of time, and a pipe system for feeding water from the tank to at least one irrigation device comprising a tube adapted to extend into the ground, and the tube being apertured to permit water supplied to the tube from the pipe system to permeate into the surrounding soil.

17. An irrigation system according to claim 16, wherein the tube extends generally vertically into the ground and the lower end portion of the tube is apertured with a plurality of holes whereby the water flow from the tube into the surrounding soil will be determined by the size and number of holes and also on the nature of the surrounding soil.

18. An irrigation system according to claim 17, wherein water is fed from the pipe system to the irrigation device via a cap applied the upper end of the tube, the cap being removable to permit inspection and cleaning of the tube.

19. An irrigation system according to claim 18, wherein the cap includes a connector for fitting to small diameter tubing for connection to the pipe system.

20. An irrigation device according to claim 18, wherein the tube has a diameter of from approximately 10 mm and a length of from approximately 120 mm.

21. An irrigation device according to claim 20, wherein the wall of the tube is apertured by holes commencing at approximately 100 mm along the length of the tube from its upper end.

22. A system according to claim 17, having a switch for selectively diverting incoming waste water to waste in preference to the tank.

23. An irrigation system according to claim 17, wherein the pipe system has at least two sections and a switch is provided to selectively block and permit the flow of water from the tank into the respective sections, each section including a plurality of said irrigation devices.

24. An irrigation system according to claim 17, wherein the flow from the tank into the pipe system is a gravity flow.

25. An irrigation system according to claim 24, wherein a water outlet leading from the tank and to which the pipe system is connected extends from a sump at the lower end of the tank whereby water can drain completely from the tank into the pipe system via the outlet.

26. A system according to claim 17, wherein the waste water is water discharged from a washing machine, and the tank includes a lint trap to trap lint within the waste water from being discharged from the tank.

27. An irrigation system according to claim 26, wherein the lint trap is a two-stage trap installed across the interior of the tank.

28. An irrigation device for use in an irrigation system according to claim 17, the device comprising a tube adapted to be buried in the ground with a lower end of the tube being apertured to permit water to permeate from the tube into the surrounding soil, and a removable cap at the upper end of the tube, the cap including a connector for connecting the tube to the pipe system to receive waste water therefrom.

29. An irrigation device according to claim 28, wherein the tube has a diameter of from approximately 10 mm and a length of from approximately 120 mm.

30. An irrigation device according to claim 29, wherein the wall of the tube is apertured by holes connecting at approximately 10 mm along the length of the tube from its upper end.

31. A tank for use in an irrigation system according to claim 17, the tank including a lint filter system for filtering lint from incoming laundry water, and an outlet extending from a sump at the bottom of the tank and from which waste water can completely drain the tank also including an overflow outlet for allowing excess water to be directed to waste.

32. A tank according to claim 31, wherein the overflow outlet is laterally offset within the tank from the tank outlet.

33. A tank according to claim 31, having a capacity of from approximately 100 liters.
